(19) United States
(12) Patent Application Publication
(10) Pub. No.: US 2016/0102884 A1
(43) Pub. Date: Apr. 14, 2016

(54) CIRCULAR AIR-CONDITIONING REGISTER

(71) Applicant: TOYODA GOSEI CO., LTD., Kiyosu-shi (JP)

(72) Inventors: Nobuhiro TERAI, Kiyosu-shi (JP); Kenji ASANO, Nagoya-shi (JP)

(21) Appl. No.: 14/847,081

(22) Filed: Sep. 8, 2015

(30) Foreign Application Priority Data
Oct. 10, 2014 (JP) 2014-208766

(51) Int. Cl. F24F 13/10; B60H 1/34

(52) U.S. Cl. CPC F24F 13/10; B60H 1/3414

(57) ABSTRACT

A circular air-conditioning register includes a tubular outlet ring, which defines a vent outlet of conditioning air, and three fin bodies, which are supported by the outlet ring to be pivotal about respective pivot axes. When the space inside the outlet ring is equally divided into three sectorial regions about the central axis of the outlet ring, each pivot axis is parallel to the chord of corresponding one of the three sectorial regions. The vent outlet is closed when the fins bodies are pivoted to a closed position. Each fin body includes a main fin, which closes the vent outlet at the closed position, and an auxiliary fin, which is spaced apart from the main fin. Each main fin and the corresponding auxiliary fin are formed integrally.

### BACKGROUND OF THE INVENTION

The present invention relates to a circular air-conditioning register having a first function for opening and closing a vent outlet of conditioning air with fins located near the vent outlet in the flow passage and a second function for radially diffusing a stream of air flowing out through the vent outlet.

An air-conditioning register that discharges conditioning air, which is fed by an air-conditioning device, through a vent outlet is installed in a vehicle instrument panel or a dashboard. Japanese Laid-Open Patent Publications No. 2009-137334 and No. 2009-107439 describe conventional circular air-conditioning registers that include circular vent outlets. The circular air-conditioning registers have a function for opening and closing the vent outlet with movable fins located in the vent outlet.

In recent years, there has been a demand for a circular air-conditioning register that has a flow diffusing function for radially diffusing air flowing out through the vent outlet so that the flow is directed to a wider area. On the other hand, reduction in the number of fins may be required to reduce the number of components or for ornamental requirements. However, simply reducing the number of fins increases the size of fins. When fully opened, the fins are parallel to the central axis of the vent outlet. Thus, the projection of the fins along the central axis of the vent outlet is increased. In addition, each fin can change the flow direction only to a limited extent. Reduction in the number of fins therefore may result in insufficient diffusion of air.

### SUMMARY OF THE INVENTION

Accordingly, it is an objective of the present invention to provide a circular air-conditioning register that suitably maintains the flow diffusion performance while limiting the number of components.

To achieve the foregoing objective and in accordance with one aspect of the present invention, a circular air-conditioning register is provided that includes a cylindrical tubular body including an inner circumferential surface that defines a vent outlet of conditioning air and one of a set of three fin bodies and a set of four fin bodies. The fin bodies are supported by the tubular body to be pivotal about respective pivot axes. When a space inside the tubular body is equally divided into sectorial regions about a central axis of the tubular body, the sectorial regions being equal in number to the fin bodies, each pivot axis is parallel to a chord of corresponding one of the sectorial regions. A front surface and a back surface of each fin body each form an air flow guide surface. In a cross-section of each fin body taken along a plane perpendicular to the pivot axis of the fin body, a position at which an angle defined by the central axis and a contour line that corresponds to any one of the air flow guide surfaces is maximized is a closed position. The vent outlet is closed when each fin body is pivoted to the closed position. Each fin body includes a main fin, which closes the vent outlet at the closed position, and an auxiliary fin, which is spaced apart from the main fin. Each main fin and the corresponding auxiliary fin are formed integrally.

With the fin bodies pivotally supported as described above, reduction in the number of fins that close the vent outlet of conditioning air at the closed position does not increase projection of the fin bodies from the vent outlet in the direction of the central axis of the tubular body when the fin bodies are fully open. This reduces the number of components of the circular air-conditioning register without spoiling the ornamental appearance or increasing the size. Further, when the fin bodies are pivoted to a position where the angle defined by the central axis and a contour line that corresponds to any one of air flow guide surfaces in a cross-section of each fin body taken along a plane perpendicular to the pivot axis of the fin body, that is, the angle of inclination of the air flow guide surfaces of the main and auxiliary fins with respect to the central axis of the tubular body is less than the angle of inclination at the closed position, the air flow guide surfaces of the main and auxiliary fins radially diffuse the conditioning air flowing out through the vent outlet in the radial direction of the tubular body. Each fin body of the circular air-conditioning register includes a main fin and an auxiliary fin, which are formed integrally. Accordingly, twice the number of fins as the fin bodies are located in the vent outlet. This allows the reduced number of fin bodies, which pivot about respective pivot axes, to diffuse flow of air in a favorable manner.

### BRIEF DESCRIPTION OF THE DRAWINGS

FIG. 1 is a plan view showing a vent outlet of a vehicle instrument panel in which a circular air-conditioning register of one embodiment is installed;

FIG. 2 is a perspective view showing the circular air-conditioning register of FIG. 1;

FIG. 3 is an exploded perspective view showing the circular air-conditioning register of FIG. 1;

FIG. 4 is a cross-sectional view taken along line 4-4 in FIG. 1, showing the circular air-conditioning register and the instrument panel;

FIG. 5 is a perspective view showing a fin body of the circular air-conditioning register of FIG. 1;

FIGS. 6A to 6D are partial cross-sectional views showing a fin body in pivotal movement and its vicinity;

FIG. 7A is a front view showing the circular air-conditioning register in a fin shut mode;

FIG. 7B is a front view showing the circular air-conditioning register in a flow diffusing mode;

FIG. 7C is a front view showing the circular air-conditioning register in a fully open mode;

FIG. 7D is a front view showing the circular air-conditioning register in a spot flow mode;

FIG. 8 is a diagram showing a cross-sectional view of the circular air-conditioning register taken along line 8-8 in FIG. 7A and a cross-sectional view of the circular air-conditioning register taken along line 8-8 in FIG. 7C;

FIG. 9 is a cross-sectional view taken along line 9-9 in FIG. 7B, showing the circular air-conditioning register;

FIG. 10 is a cross-sectional view taken along line 10-10 in FIG. 7D, showing the circular air-conditioning register;

FIG. 11A is a perspective view showing a vent outlet in the closed mode of an example of a circular air-conditioning register that includes fins of a radial axis pivot structure;

FIG. 11B is a perspective view showing the vent outlet of the circular air-conditioning register of FIG. 11A in the flow diffusing mode;

FIG. 12 is a front view showing a circular air-conditioning register that includes four fins;

FIG. 13A is a partial cross-sectional view showing the circular air-conditioning register in the fully open mode in which the pivot axis of the fin is the axis X shown in FIG. 12;

FIG. 13B is a partial cross-sectional view showing the circular air-conditioning register in the fully open mode in which the pivot axis of the fin is the axis Y shown in FIG. 12;

FIG. 13C is a partial cross-sectional view showing the circular air-conditioning register in the fully open mode in which the pivot axis of the fin is the axis Z shown in FIG. 12;

FIG. 14 is a diagram showing how conditioning air flows out through a circular air-conditioning register that is in the diffusion mode and includes three fins that pivot about respective pivot axes; and

FIG. 15 is a perspective view showing fin bodies of a modification.

### DETAILED DESCRIPTION OF THE PREFERRED EMBODIMENTS

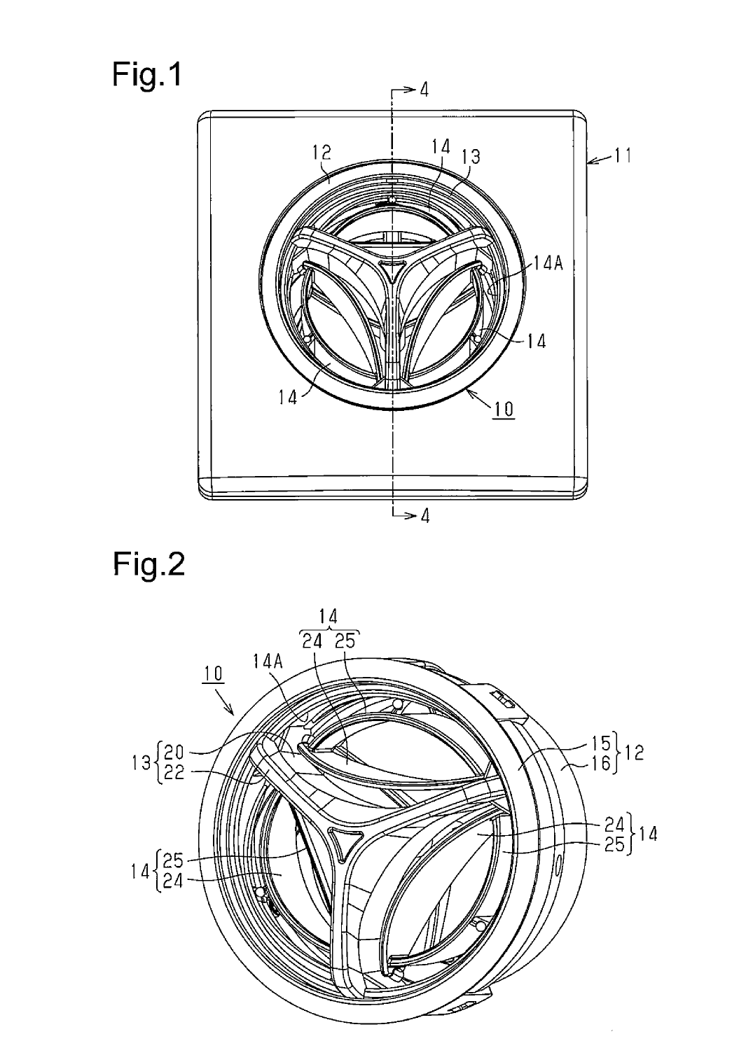

Referring to FIGS. 1 to 14, a circular air-conditioning register 10 according to one embodiment will now be described. The circular air-conditioning register 10 of the present embodiment is installed in the instrument panel of a vehicle.

As shown in FIG. 1, the circular air-conditioning register 10 of the present embodiment is coupled to a vent outlet of conditioning air in an instrument panel 11 of the vehicle. The conditioning air fed by an air-conditioning device of the vehicle flows out through the circular air-conditioning register 10 into the passenger compartment. In the following descriptions, the upstream side in the flow direction of conditioning air in the circular air-conditioning register 10 is referred to as the register rear side, and the downstream side in the flow direction of conditioning air is referred to as the register front side.

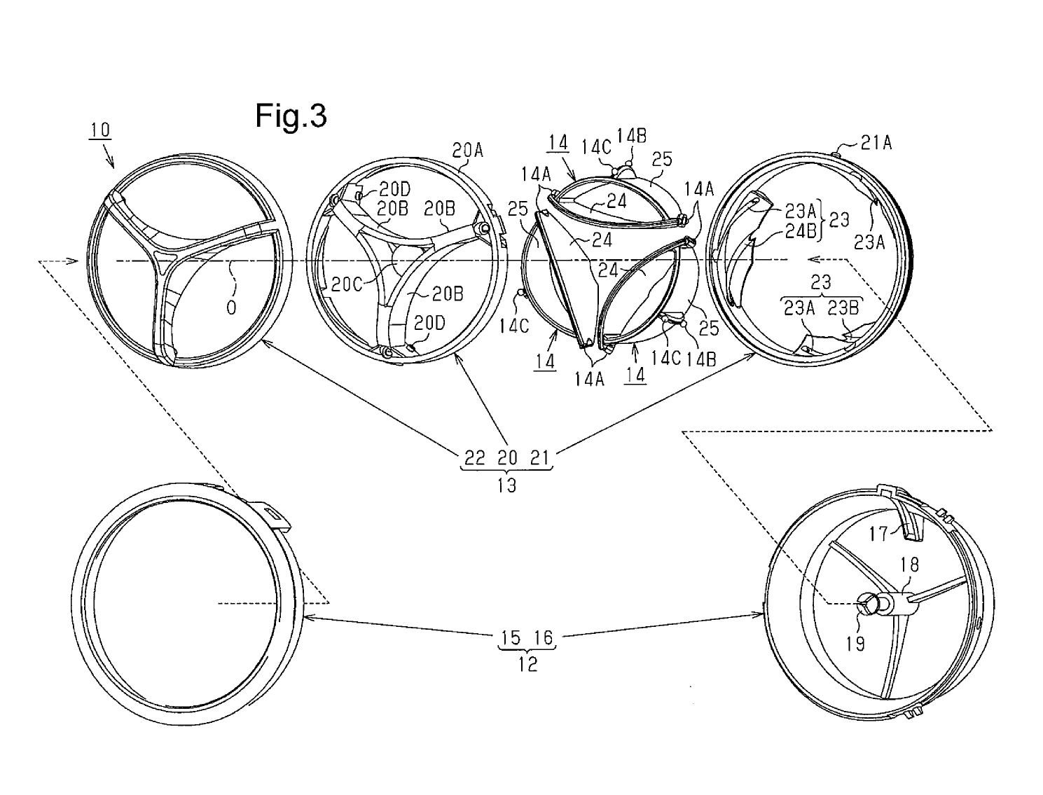

As shown in FIGS. 2 and 3, the circular air-conditioning register 10 includes a retainer 12, which is fixed to the instrument panel 11, an outlet ring 13, which serves as a tubular body and is located on the inner side of the retainer 12, and three fin bodies 14, which are located on the inner side of the outlet ring 13. The inner circumferential surface of the retainer 12 defines a part of the passage of conditioning air. The inner circumferential surface of the outlet ring 13 defines a vent outlet 13A of conditioning air.

The retainer 12 includes a ring-shaped retainer front portion 15 and a retainer rear portion 16, which has a spherical inner circumferential surface. The inner circumferential surface of the retainer rear portion 16 includes an engagement groove 17 extending in the direction of the central axis of the retainer 12. The retainer rear portion 16 includes a rod-shaped support shaft 18 extending toward the register front side along the central axis of the retainer 12. The distal end of the support shaft 18 includes a spherical bearing ball 19.

The outlet ring 13 has a spherical outer circumferential surface. When the outlet ring 13 is placed in the retainer 12, the outer circumferential surface of the outlet ring 13 is in slide contact with the spherical inner circumferential surface of the retainer rear portion 16. The outlet ring 13 includes a ring front portion 20, which serves as a first tubular member, a ring base 21, which serves as a second tubular member, and a bezel 22, which covers the register front side of the ring front portion 20. The bezel 22 is a decorative trim. The ring front portion 20 and the bezel 22 are coupled to the ring base 21 to be rotational relative to the ring base 21 and about the central axis O of the outlet ring 13.

The ring front portion 20 includes an annular rim 20A and three spokes 20B. The three spokes 20B extend from the inner circumferential surface of the rim 20A at uniform intervals in the circumferential direction. The spokes 20B extend radially inward of the rim 20A and are connected to one another at the center of the rim 20A. The connection section of the spokes 20B includes a spherical bearing 20C, which engages with the bearing ball 19 of the retainer 12. Further, support protrusions 20D protrude from opposite sides of the spoke 20B in each of the connection sections between the spokes 20B and the rim 20A.

The outer circumferential surface of the ring base 21 includes a protrusion 21A, which engages with the engagement groove 17 in the inner circumferential surface of the retainer rear portion 16. The inner circumferential surface of the ring base 21 is curved such that the inner diameter decreases toward the register rear side. The inner circumferential surface of the ring base 21 includes three guide groove pairs 23 located at uniform intervals in the circumferential direction. Each guide groove pair 23 includes a first guide groove 23A and a second guide groove 23B, which extend helically along the inner circumferential surface of the ring base 21 and in parallel to each other.

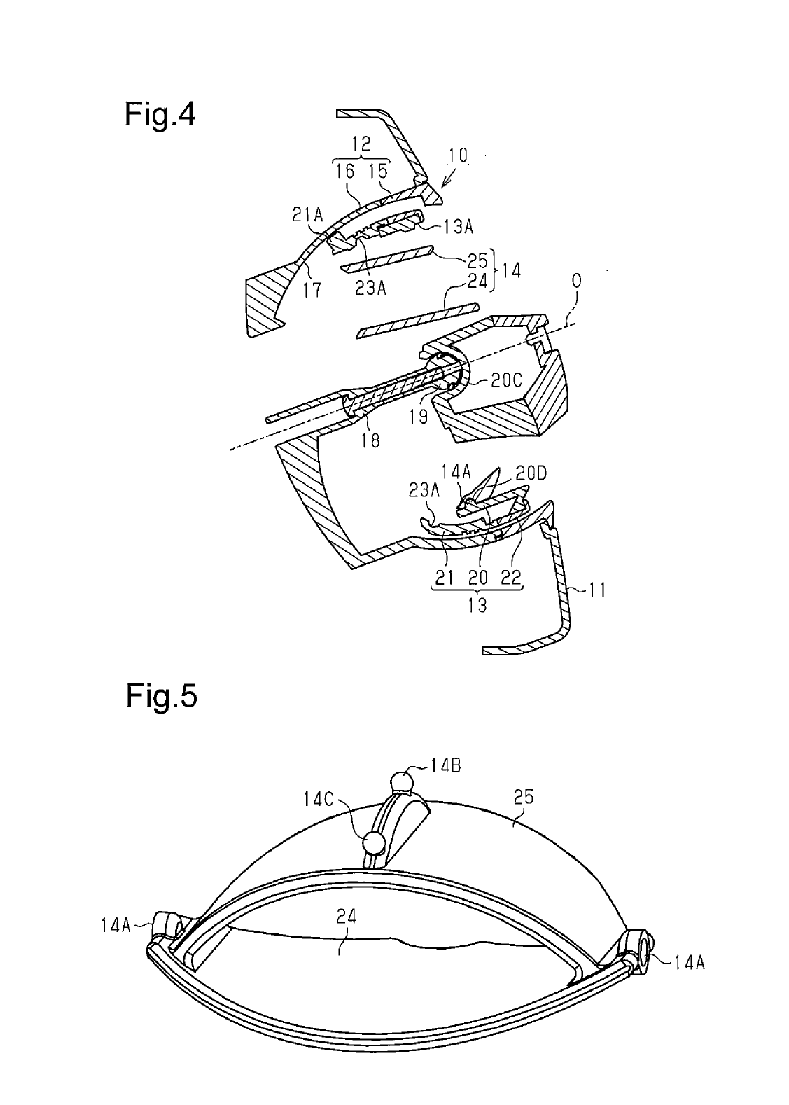

As shown in FIG. 4, the outer circumferential surface of the retainer front portion 15 of the retainer 12 is fixed to the instrument panel 11. The engagement between the bearing ball 19 and the spherical bearing 20C and the engagement between the protrusion 21A and the engagement groove 17 position the outlet ring 13 in the retainer 12 such that the outlet ring 13 can pivot about the center of the bearing ball 19. Pivoting of the outlet ring 13 changes the orientation of the central axis O of the outlet ring 13, thereby changing the flow direction of conditioning air. The engagement between the protrusion 21A and the engagement groove 17 limits rotation of the ring base 21 about the central axis O of the outlet ring 13.

As shown in FIG. 5, each fin body 14 of the circular air-conditioning register 10 includes a main fin 24 and an auxiliary fin 25, which are formed integrally. The main fin 24 and the auxiliary fin 25 each have end sections that are opposite in the circumferential direction of the outlet ring 13 when the fins 24 and 25 are pivotally supported by the outlet ring 13. The main fin 24 and the auxiliary fin 25 are connected to each other at the end sections. Thus, the fin body 14 as a whole is tubular. The front and back surfaces of the main fin 24 and the auxiliary fin 25 of each fin body 14 each form an air flow guide surface, which guides the flow of conditioning air.

Each fin body 14 includes two engagement holes 14A, into which the support protrusions 20D are fitted. The opposing two support protrusions 20D of two adjacent spokes 20B are fitted into the two engagement holes 14A of each fin body 14 so that the fin body 14 is pivotally supported by the ring front portion 20. When the space inside the outlet ring 13 is equally divided into three sectorial regions about the central axis O, the pivot axis of each fin body 14 is parallel to the chord of the corresponding one of the three sectorial regions.

Each fin body 14 includes a spherical first protrusion 14B and a spherical second protrusion 14C, which protrude from the outer circumferential surface of the fin body 14. The first protrusion 14B and the second protrusion 14C are respectively engaged with the first guide groove 23A and the second guide groove 23B formed in the inner circumferential surface of the ring base 21. When the ring front portion 20 is rotated relative to the ring base 21, the first and second guide grooves 23A and 23B guide the first and second protrusions 14B and 14C in the direction of the central axis O of the outlet ring 13, thereby pivoting the fin bodies 14.

Operation of the circular air-conditioning register 10 of the present embodiment will now be described.

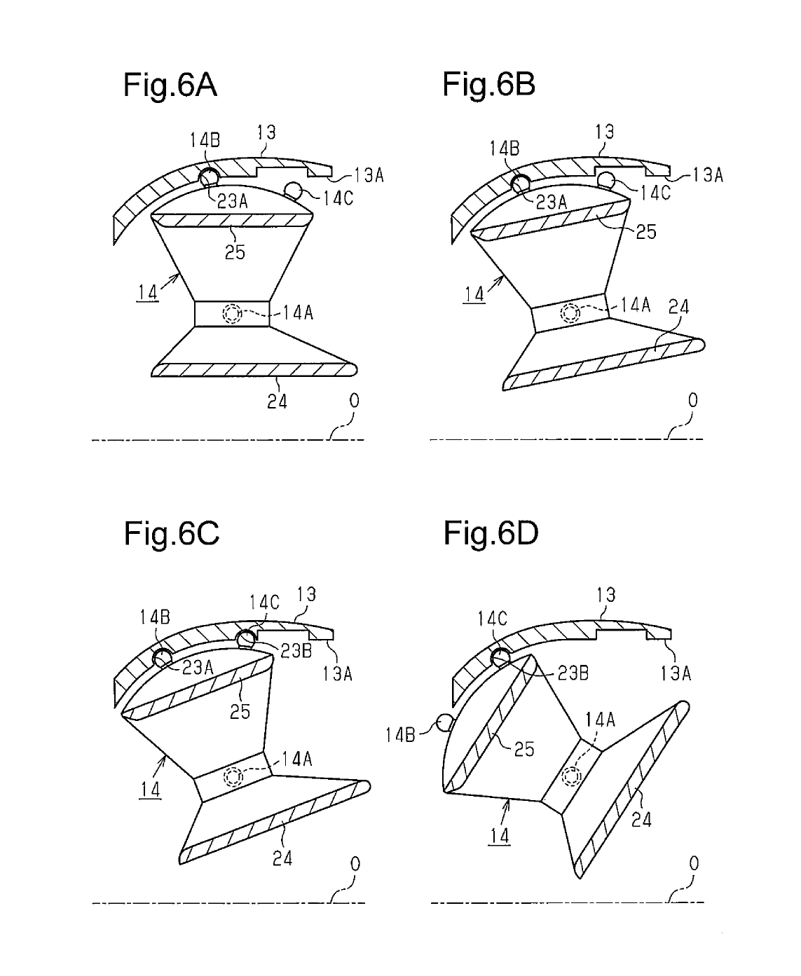

When a spoke 20B is manipulated by fingers, for example, to rotate the ring front portion 20, the angle of inclination of the fin bodies 14 is changed. This changes the flow mode of conditioning air of the circular air-conditioning register 10. The angle of inclination of the fin bodies 14 is the angle formed by the central axis O of the outlet ring 13 and a contour line that corresponds to any one of the air flow guide surfaces in a cross-section of each fin body 14 taken along a plane perpendicular to the pivot axis of the fin body 14. The angle of inclination of the fin bodies 14 in the circular air-conditioning register 10 is changed as described below. In FIG. 6A, the fin body 14 is located at a position where the air flow guide surfaces of the main fin 24 and the auxiliary fin 25 are parallel to the central axis O of the outlet ring 13. This position corresponds to the fully open position. Of the two protrusions 14B and 14C on the outer circumferential surface of the fin body 14, the first protrusion 14B, which is located on the register rear side, engages with the first guide groove 23A. When the ring front portion 20 is rotated relative to the ring base 21 from this position, the engagement position between the first protrusion 14B and the first guide groove 23A moves toward the register rear side as shown in FIG. 6B. This increases the angle of inclination of the fin body 14.

As shown in FIG. 6C, further rotating the ring front portion 20 from the position shown in FIG. 6B further increases the angle of inclination of the fin body 14 and brings the second protrusion 14C into engagement with the second guide groove 23B. Here, the first protrusion 14B and the second protrusion 14C engage with the first guide groove 23A and the second guide groove 23B, respectively. In this state, rotating the ring front portion 20 relative to the ring base 21 moves the engagement positions between the first guide groove 23A and the first protrusion 14B and between the second guide groove 23B and the second protrusion 14C in the register front-rear direction, thereby changing the angle of inclination of the fin body 14.

As shown in FIG. 6D, further rotating the ring front portion 20 from the position shown in FIG. 6C disengages the first protrusion 14B from the first guide groove 23A, whereas the engagement between the second guide groove 23B and the second protrusion 14C is maintained. In this state, rotating the ring front portion 20 relative to the ring base 21 moves the engagement position between the second guide groove 23B and the second protrusion 14C in the register front-rear direction, thereby changing the angle of inclination of the fin body 14.

The angle of inclination of each fin body 14 can be changed by using a single protrusion and a single guide groove. However, in such a case, a longer groove would be needed to sufficiently change the angle of inclination of the fin body 14. A longer groove would increase the dimension of the ring base 21 in the direction of the central axis O of the outlet ring 13. In this respect, the present embodiment includes two protrusions 14B and 14C and two guide grooves 23A and 23B. Switching between the guide grooves 23A and 23B to guide the protrusions 14B and 14C while the fin body 14 is pivoted reduces the length of the guide groove required to sufficiently change the angle of inclination of the fin body 14.

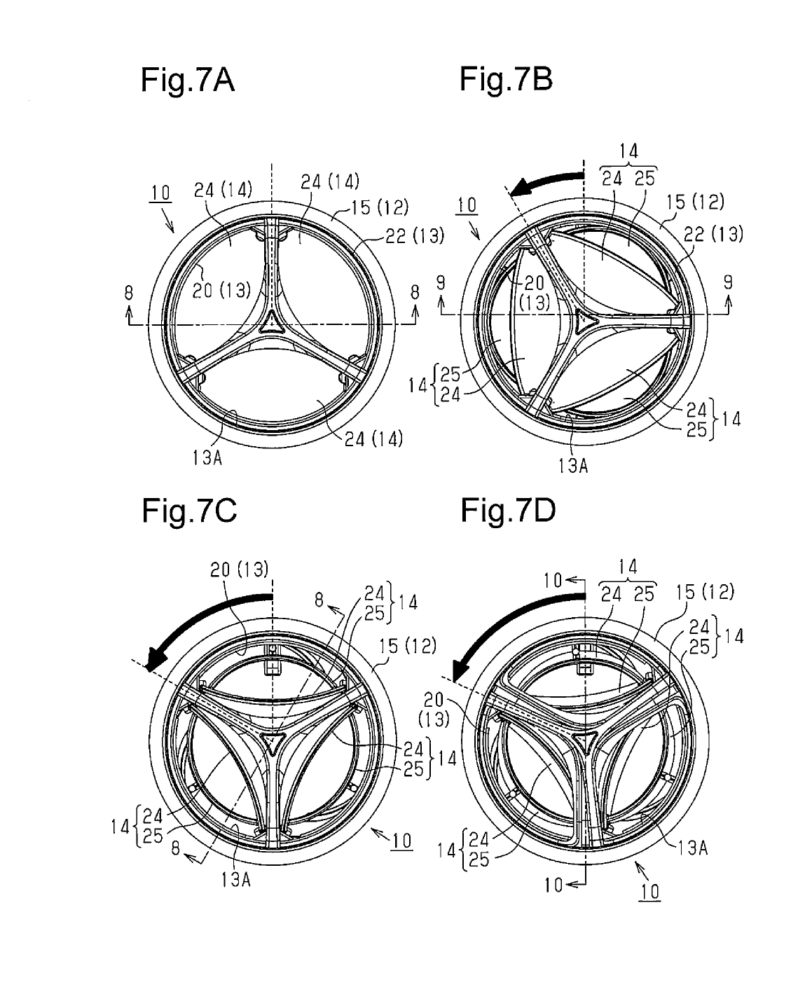

As shown in FIGS. 7A to 7D, the flow mode of conditioning air of the circular air-conditioning register 10 is changed according to the angle of inclination of the fin bodies 14, which is changed as the ring front portion 20 rotates relative to the ring base 21. FIG. 7A is a front view showing the circular air-conditioning register 10 in the closed mode. FIG. 7B is a front view showing the circular air-conditioning register 10 in the flow diffusing mode. FIG. 7C is a front view showing the circular air-conditioning register 10 in the fully open mode. FIG. 7D is a front view showing the circular air-conditioning register 10 in the spot mode. As shown in FIGS. 7A to 7D, as the rotation amount of the ring front portion 20 relative to the ring base 21 is increased from the closed mode shown in FIG. 7A in a counterclockwise direction, the flow mode of the circular air-conditioning register 10 is changed to the flow diffusing mode, to the fully open mode, and to the spot mode in this order.

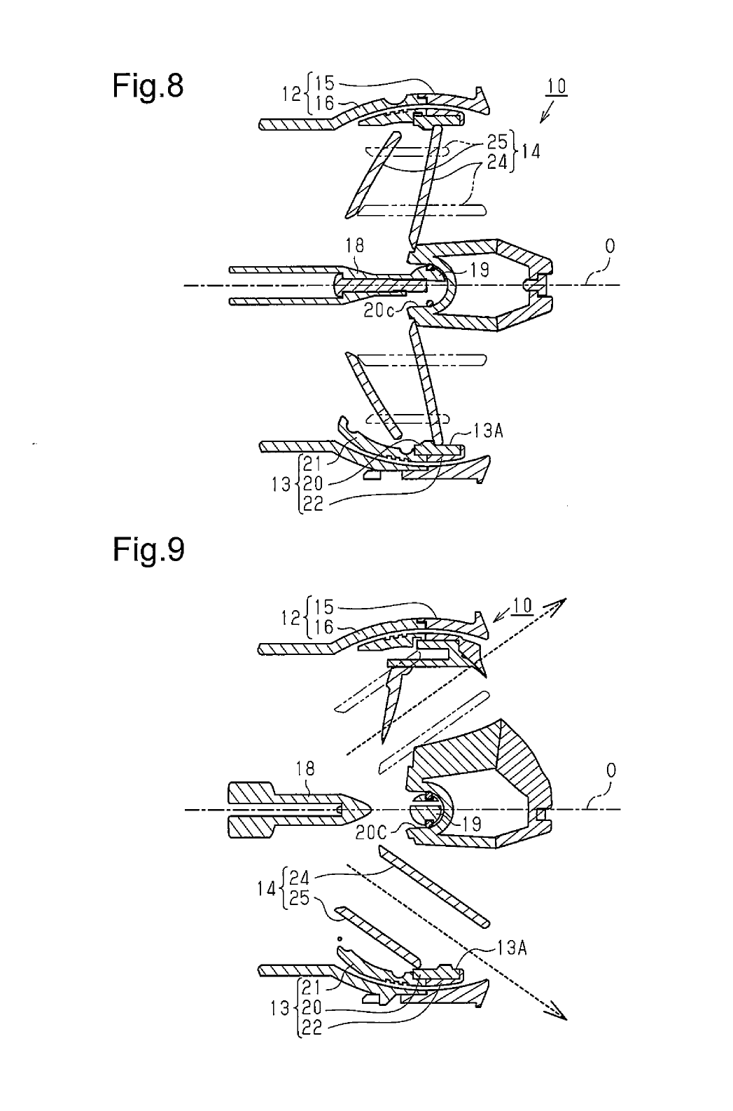

The solid lines in FIG. 8 indicate the inner state of the circular air-conditioning register 10 in the closed mode. In this state, the fin bodies 14 are pivoted to a position where the angle of inclination is maximized. This position corresponds to the closed position. In this state, the main fins 24 close the vent outlet 13A of conditioning air, which is defined by the inner circumferential surface of the outlet ring 13, blocking outflow of conditioning air from the vent outlet 13A.

The long dashed double-short dashed lines in FIG. 8 indicate the position of the fin body 14 in the fully open mode. The fin bodies 14 in the fully open mode are pivoted to the fully open position, where the air flow guide surfaces of the main fins 24 and the auxiliary fins 25 are parallel to the central axis O of the outlet ring 13. Here, conditioning air flows out through the vent outlet 13A along the central axis O of the outlet ring 13. In the fully open mode, the conditioning air experiences minimum pressure drop when passing through the circular air-conditioning register 10.

FIG. 9 shows the inner state of the circular air-conditioning register 10 in the flow diffusing mode. The fin bodies 14 in the flow diffusing mode are pivoted to a position where the angle of inclination of the fin bodies 14 is the intermediate angle between the angle in the closed mode and the angle in the fully open mode. In other words, each fin body 14 in the flow diffusing mode is arranged such that the air flow guide surfaces become farther away from the central axis O toward the front side of the register 10, that is, toward the downstream side in the direction of flow of the conditioning air. Here, conditioning air flows out through the vent outlet 13A to be dispersed in the radial direction of the vent outlet 13A. Thus, the air flow is directed to a wider area in the passenger compartment.

FIG. 10 shows the inner state of the circular air-conditioning register 10 in the spot flow mode. The fin bodies 14 in the spot flow mode are pivoted to a position where the air flow guide surfaces are inclined in the direction opposite to the direction in which the air flow guide surfaces are inclined when the fin bodies 14 move from the fully open position to the closed position. In other words, each fin body 14 in the spot flow mode is arranged such that the air flow guide surfaces become closer to the central axis O toward the front side of the register 10, that is, toward the downstream side in the direction of flow of the conditioning air. This position corresponds to the spot flow position. Here, conditioning air flows out through the vent outlet 13A to converge to a point on an extension of the central axis O of the outlet ring 13.

As described above, the circular air-conditioning register 10 has a first function for closing the vent outlet 13A with the fin bodies 14, a second function for radially diffusing the flow of air, and a third function for converging the flow of air to one point. The first function and the second function may also be performed by the following structure.

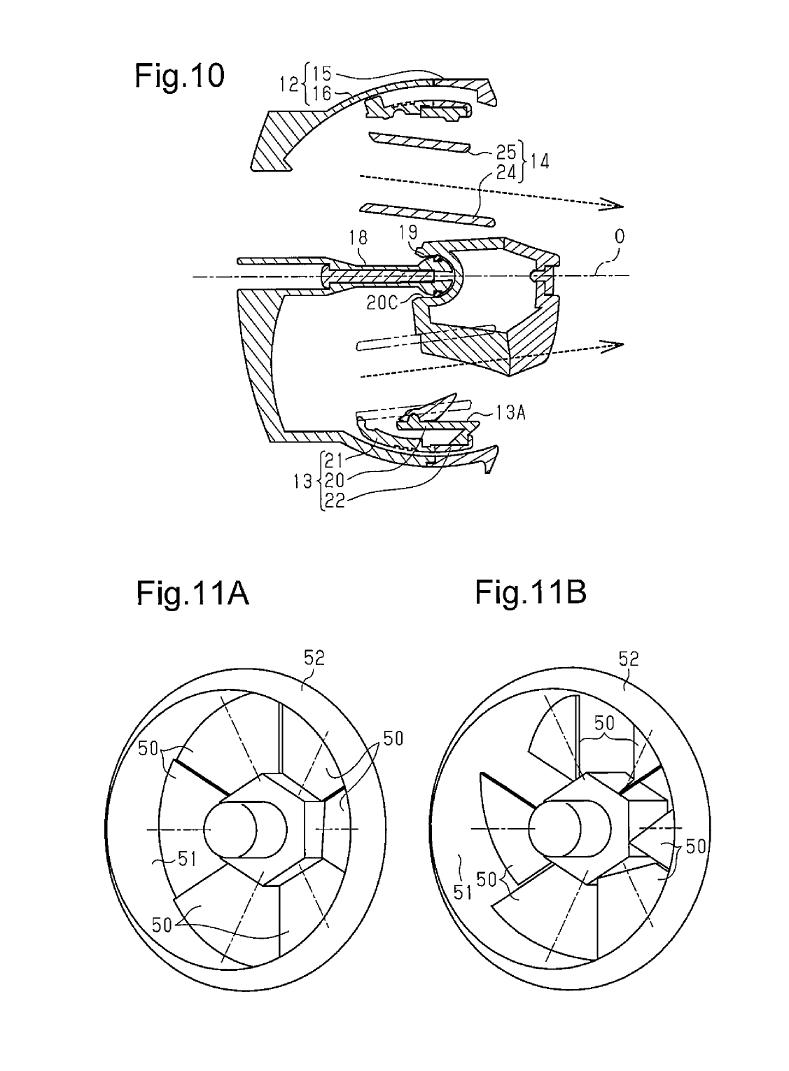

FIGS. 11A and 11B are perspective views showing the structure including the vent outlet of a circular air-conditioning register according to another example that performs the first function and the second function. FIG. 11A shows the structure including the vent outlet in the closed mode, and FIG. 11B shows the structure including the vent outlet in the flow diffusing mode.

The circular air-conditioning register shown in FIGS. 11A and 11B includes an outlet ring 52, which has an inner circumferential surface that defines a vent outlet 50, and six fins 51, which are located on the inner side of the outlet ring 52. The fins 51 are pivotally supported by the outlet ring 52 to be pivotal about respective pivot axes extending in radial directions of the outlet ring 52. In this circular air-conditioning register, the fins 51 close the vent outlet 50 when pivoted to a position where the opposite ends in the circumferential direction of the adjacent fins 51 overlap with each other as shown in FIG. 11A. That is, this circular air-conditioning register has the first function. Further, pivoting the fins 51 to incline the air flow guide surfaces as shown in FIG. 11B radially diffuses conditioning air. That is, this circular air-conditioning register has the second function.

Increase in the number of fins that pivot about the respective pivot axes increases the number of components. In addition, a more complicated mechanism needed to pivot the increased number of fins also increases the number of components. Thus, it is desirable to reduce the number of fins to simplify the structure of the circular air-conditioning register 10. Reduction in the number of fins may also be required for design reasons. However, in a structure like the example described above in which the fins 51 pivot about the axes extending in radial directions of the outlet ring 52 (such a pivotal support structure of fins is hereinafter referred to as “radial axis pivot structure”), reducing the number of fins 51 to four or less is difficult for the reasons described below.

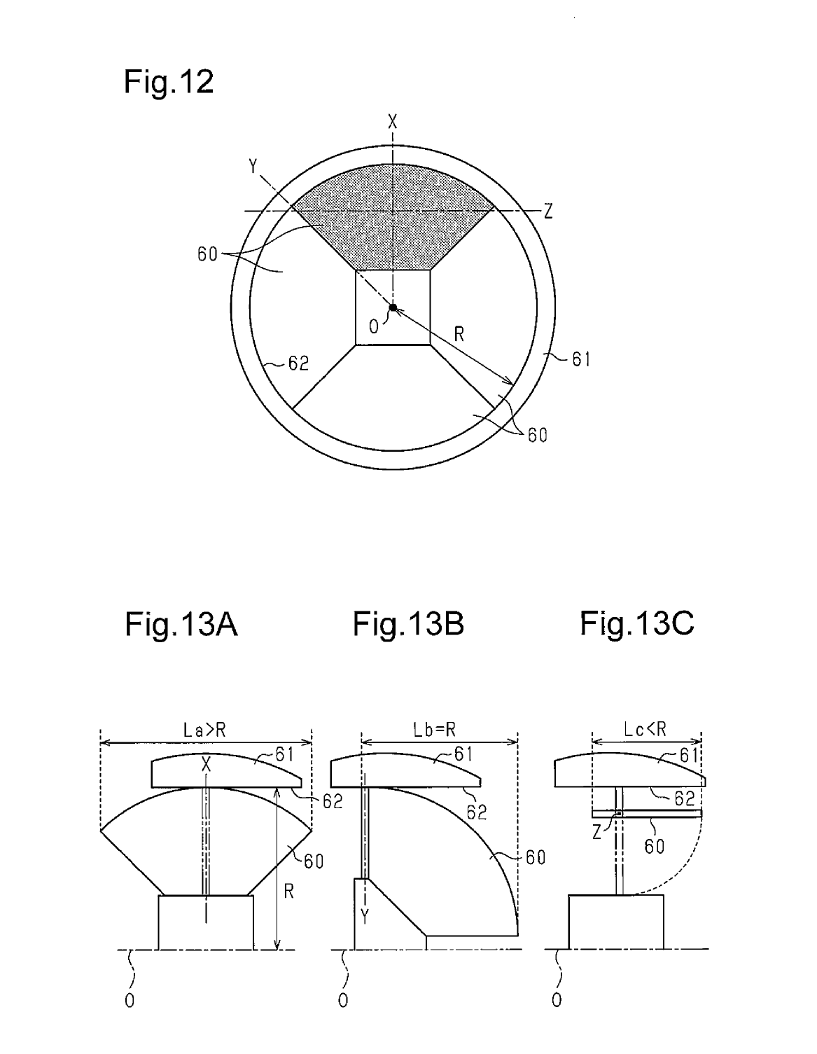

FIG. 12 shows a circular air-conditioning register in the closed mode. This circular air-conditioning register includes an outlet ring 61 and four fins 60, which are located in a vent outlet 62 defined by the inner circumferential surface of the outlet ring 61. The circular air-conditioning register has the first function and the second function. Structures in which an axis X, an axis Y, and an axis Z serve as pivot axes of the fin 60 that is located at the uppermost position as viewed in FIG. 12 are described below. The axis X extends in a radial direction of the outlet ring 61 and passes through the center of the arcuate section of the fin 60 in the closed mode. The axis Y extends in a radial direction of the outlet ring 61 along a radial edge of the fin 60 in the closed mode. The axis Z is parallel to the chord of the corresponding one of four sectorial regions, which are defined by equally dividing the vent outlet 62 into four regions about the central axis O of the outlet ring 61. In the following descriptions, the fin support structure in which an axis that is parallel to the chord of a sector serves as the pivot axis is referred to as “chord axis pivot structure.”

FIGS. 13A to 13C show fins 60 that pivot about the axis X, the axis Y, and the axis Z, respectively. These fins 60 are in the fully open mode, and their air flow guide surfaces are parallel to the central axis O of the outlet ring 61. As shown in FIG. 13A, when the pivot axis of the fin 60 is the axis X, the dimension La in the direction of the central axis O of the fin 60 in the fully open mode is greater than the radius R of the vent outlet 62. As shown in FIG. 13B, when the pivot axis of the fin 60 is the axis Y, the dimension Lb in the direction of the central axis O of the fin 60 in the fully open mode is equal to the radius R of the vent outlet 62. With the radial axis pivot structure, the dimension in the direction of the central axis O of the fin 60 in the fully open mode is minimized when the pivot axis is the axis Y. As shown in FIG. 13C, when the pivot axis of the fin 60 is the axis Z, the dimension Lc in the direction of the central axis O of the fin 60 in the fully open mode is less than the radius R of the vent outlet 62. Therefore, when four fins 60 are used, the chord axis pivot structure limits projection of the fin 60 from the vent outlet 62 in the direction of the central axis O of the outlet ring 61 compared to the radial axis pivot structure.

Such a tendency is more evident when three fins are used. Thus, in performing the first function and the second function with three or four fins, the chord axis pivot structure limits projection of the fins from the vent outlet and reduces the size of the circular air-conditioning register compared to the radial axis pivot structure. In addition, the spot flow function, which is difficult to perform with the radial axis pivot structure, is easier to perform with the chord axis pivot structure. However, the following problems may occur when a reduced number of fins are used.

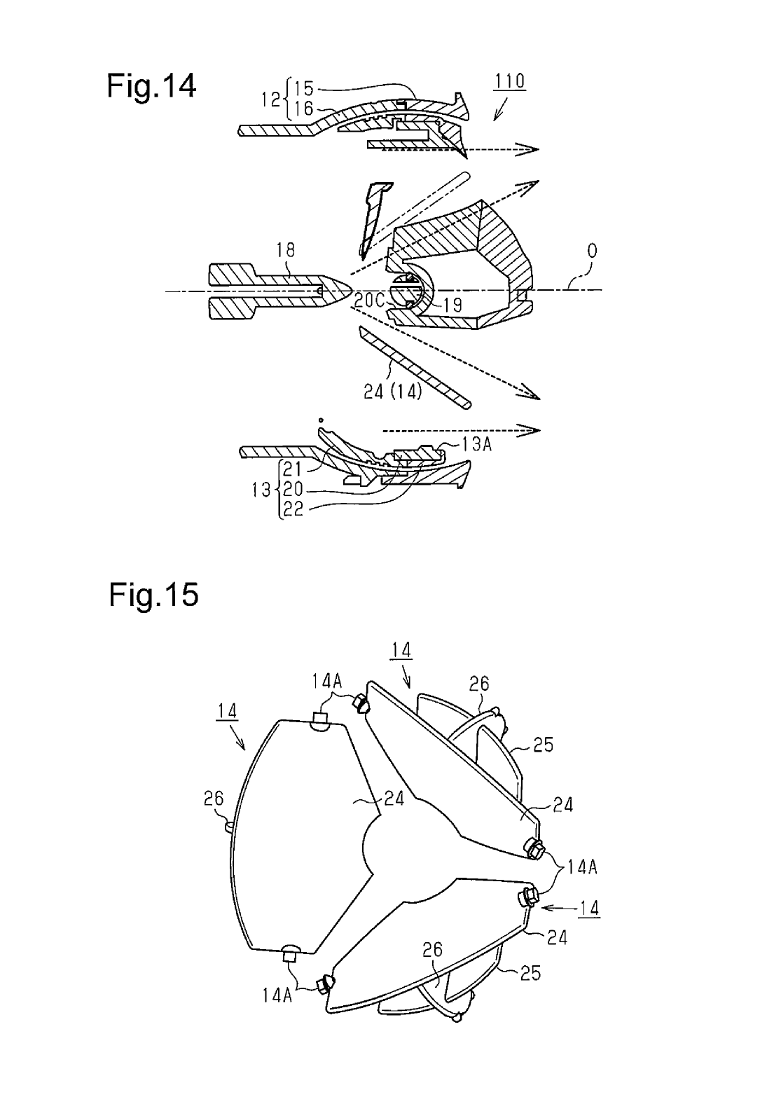

FIG. 14 shows the inner state of a circular air-conditioning register 110 in the flow diffusing mode. The circular air-conditioning register 110 includes three fin bodies 14. Each fin body 14 of the circular air-conditioning register 110 is of a single fin structure, which includes only a main fin 24 and does not include an auxiliary fin 25. As shown in FIG. 14, the circular air-conditioning register 110, which includes only three main fins 24, has a large gap between the inner circumferential surface of the vent outlet 13A and the fin bodies 14 in the flow diffusing mode. Thus, much of the conditioning air passing through the vent outlet 13A directly flows out without coming into contact with and being guided by the air flow guide surfaces of the fin bodies 14 (main fins 24). This limits the diffusion performance. Such a problem also occurs in the spot flow mode, where reduction in the number of fins inhibits convergence of air.

In contrast, the three fin bodies 14 used in the circular air-conditioning register 10 of the present embodiment each include a main fin 24 and an auxiliary fin 25, which are formed integrally. In other words, each fin body 14 of the circular air-conditioning register 10 includes two fins that are formed integrally. The presence of the main fins 24 and the auxiliary fins 25 allows twice the number of fins as the fin bodies 14 to be located in the vent outlet 13A while limiting the number of components by reducing the number of the fin bodies 14 that pivot about the respective pivot axes. This facilitates the diffusion and convergence of air.

The circular air-conditioning register 10 of the present embodiment achieves the following advantages.

(1) Each fin body 14 is pivotally supported by the outlet ring 13. When the space inside the outlet ring 13 is equally divided into three sectorial regions about the central axis O, the pivot axis of each fin body 14 is parallel to the chord of the corresponding one of the three sectorial regions. This limits increase in the projection amount of the fin body 14 from the vent outlet 13A in the direction of the central axis O in the fully open mode, which would otherwise be caused by the reduction in the number of fin bodies 14. Accordingly, such a structure improves the design and limits enlargement of the circular air-conditioning register 10 while limiting the number of components.

(2) Each fin body 14 includes the main fin 24, which closes the vent outlet 13A in the closed position, and the auxiliary fin 25, which is spaced apart from the main fin 24. The main fin 24 and the auxiliary fin 25 are formed integrally. Thus, despite the reduced number of the fin bodies 14 pivoted about the respective pivot axes, the conditioning air flowing out through the vent outlet 13A in the flow diffusing mode is diffused in a satisfactory manner.

(3) Similarly, despite the reduced number of the fin bodies 14 pivoted about the respective pivot axes, the conditioning air flowing out through the vent outlet 13A in the spot flow mode converges in a satisfactory manner.

(4) Despite the reduced number of the fin bodies 14 pivoted about the respective pivot axes, the number of the fins used to change the flow direction of conditioning air can be increased. This maintains satisfactory flow diffusion performance while limiting the number of components.

(5) The outlet ring 13 includes the ring front portion 20, which pivotally supports the fin bodies 14, and the ring base 21, which is rotational relative to the ring front portion 20. The ring base 21 includes the first and second guide grooves 23A and 23B, which guide the first and second protrusions 14B and 14C, which protrude from the fin bodies 14, in the direction of the central axis O of the outlet ring 13 in accordance with rotation of the ring base 21 relative to the ring front portion 20. Thus, pivoting of the fin bodies 14 of the chord axis pivot structure is achieved by a relatively simple mechanism.

(6) To pivot each fin body 14, the circular air-conditioning register 10 includes two protrusions 14B and 14C and two guide grooves 23A and 23B. The guide grooves 23A and 23B, which guide the protrusions 14B and 14C, are switched while the fin body 14 pivots. Accordingly, a large change amount of the angle of inclination of the fin body 14 is achieved by the relatively short guide grooves 23A and 23B. This reduces the size of the ring base 21, which includes the guide grooves 23A and 23B in its inner circumferential surface, thereby reducing the size of the circular air-conditioning register 10.

The above described embodiment may be modified as follows.

### <Regarding Shape of Fin Body 14>

The fin body 14 may have any shape as long as the main fin 24, which closes the vent outlet 13A in the closed position, and the auxiliary fin 25, which is spaced apart from the main fin 24, are formed integrally. FIG. 15 shows an example of a modification of the fin body 14. The fin body 14 shown in FIG. 15 includes a support 26 that projects perpendicularly from the main fin 24 and connects the main fin 24 to the auxiliary fin 25.

Each fin body 14 may include a main fin 24 and two or more auxiliary fins 25.

### <Regarding Pivot Mechanism of Fin Body 14>

Each fin body 14 may be pivoted by a single protrusion that protrudes from the fin body 14 and a single guide groove that is formed in the inner circumferential surface of the outlet ring 13. In this case, extending the guide groove to have a sufficient length allows the fin body 14 to be pivoted in a similar manner as the above illustrated embodiment.

The fin bodies 14 do not have to be pivoted by the mechanism that pivots the fin bodies 14 by moving the protrusions along the guide grooves along the central axis O of the outlet ring 13 in accordance with rotation of the ring front portion 20 relative to the ring base 21. For example, the fin bodies 14 may be pivoted by a link mechanism or a gear mechanism.

### <Regarding Spot Flow Mode>

The spot flow mode may be omitted from the selectable flow modes. In this case, the fin bodies 14 pivot between the closed position and the fully open position.

### <Change of Orientation of Vent Outlet 13A>

In the circular air-conditioning register 10 described above, the outlet ring 13 can pivot relative to the retainer 12, allowing the orientation of the vent outlet 13A in the instrument panel 11 to be changed according to the pivotal movement. However, the orientation of the vent outlet 13A may be fixed. In this case, the outlet ring 13 is omitted, and the retainer 12 supports the fin bodies 14 and serves as a tubular body.

### <Regarding Application>

The circular air-conditioning register 10 may be installed in a position other than the instrument panel 11 in the passenger compartment, such as a dashboard.

The air-conditioning register described above is not limited to be used in a vehicle and may be applicable to a variety of air-conditioning registers that change the direction of conditioning air, which is fed by an air-conditioning device and flows out through a vent outlet into an interior, and include a shut-off damper that opens and closes a flow passage.

1. A circular air-conditioning register comprising:
a cylindrical tubular body including an inner circumferential surface that defines a vent outlet of conditioning air; and
one of a set of three fin bodies and a set of four fin bodies, wherein the fin bodies are supported by the tubular body to be pivotal about respective pivot axes, wherein
when a space inside the tubular body is equally divided into sectorial regions about a central axis of the tubular body, the sectorial regions being equal in number to the fin bodies, each pivot axis is parallel to a chord of corresponding one of the sectorial regions,
a front surface and a back surface of each fin body each form an air flow guide surface,
in a cross-section of each fin body taken along a plane perpendicular to the pivot axis of the fin body, a position at which an angle defined by the central axis and a contour line that corresponds to any one of the air flow guide surfaces is maximized is a closed position,
the vent outlet is closed when each fin body is pivoted to the closed position,
each fin body includes a main fin, which closes the vent outlet at the closed position, and an auxiliary fin, which is spaced apart from the main fin, and
each main fin and the corresponding auxiliary fin are formed integrally.

2. The circular air-conditioning register according to claim 1, wherein
each fin body is arranged such that, when at a fully open position, the air flow guide surfaces are parallel to the central axis,
each fin body is arranged such that, when at a spot flow position, the air flow guide surfaces become closer to the central axis toward a downstream end in a direction of flow of the conditioning air, and
each fin body is configured to be pivoted from the fully open position to the spot flow position.

3. The circular air-conditioning register according to claim 1, wherein each of the main fins and the corresponding auxiliary fin are connected to each other at end sections that are opposite in a circumferential direction of the tubular body in a state in which the main fin and the auxiliary fin are supported by the tubular body.

4. The circular air-conditioning register according to claim 1, wherein
each main fin includes a support that projects perpendicularly from the main fin, and
each main fin and the corresponding auxiliary fin are connected to each other via the support.

5. The circular air-conditioning register according to claim 1, wherein
the tubular body includes a first tubular member, which pivotally supports the fin bodies, and a second tubular member, which is rotational relative to the first tubular member,
each fin body includes a protrusion, and
the second tubular member includes guide grooves, each of which guides one of the protrusions in a direction of the central axis of the tubular body in accordance with rotation of the second tubular member relative to the first tubular member.
